(19) United States
(12) Patent Application Publication
(10) Pub. No.: US 2009/0138435 A1
(43) Pub. Date: May 28, 2009

(54) TECHNIQUES FOR SEARCHING AND PRESENTING SEARCH RESULTS

(76) Inventors: Leslie Mannion, Wake Forest, NC (US); Michael Chaves, Cary, NC (US); Jason Stone, Holly Springs, NC (US); Marcus Tidwell, North Royalton, OH (US); Gonzalo Hidalgo, Holly Springs, NC (US)

Correspondence Address: JAMES M. STOVER;TERADATA CORPORATION, 2835 MIAMI VILLAGE DRIVE, MIAMISBURG, OH, 45342, US

(21) Appl. No.: 11/944,734

(22) Filed: Nov. 26, 2007

(51) Int. Cl. G06F 17/30

(52) U.S. Cl. 707/3; 707/E17.076

(57) ABSTRACT

Techniques for searching and presenting search results to a user are provided. A search is decomposed into sub search combinations. Logical operator ordering is maintained within each sub search combination and each sub search combination is processed to acquire a waterfall count for the resulting answer set associated with processing that sub search combination. The sub search combinations and their waterfall counts are then presented to the user for visual inspection and analysis.

### BACKGROUND

Enterprises are increasingly capturing, storing, and mining a plethora of information related to communications with their customers. Often this information is stored and indexed within databases. Once the information is indexed, queries are developed on an as-needed basis to mine the information from the database for a variety of organizational goals: such as planning, analytics, reporting, etc.

Often an analyst associated with an enterprise has a business problem to solve or business question to answer that entails analyzing information from the enterprise's database. The results in a query that the analyst develops to search the database. The database can be very large and the search can be fairly complicated having numerous components.

Some components of the search may not be as important as other components of the search to the analyst. Yet, the analyst may not realize this until after much iteration of refining, processing, and decomposing the initial search. It may also be that the analyst would likely alter or remove some portions of the search if the analyst knew the number or items that those portions would return when processed against the database. This entire process is largely manual and time consuming for the analyst and during this time business opportunities may be missed.

Thus, it can be seen that from the perspective of a business analyst improved mechanisms for searching and presenting search results are needed.

### SUMMARY

In various embodiments, techniques for searching and presenting results are provided. According to an embodiment, a method for processing a database search and presenting the results is described. A search is received having first criteria and second criteria. A first search for the search is processed to acquire first results. Next, a second search for the search is processed to acquire second results. The search itself is then processed to obtain third results. The first search is then presented along with a first number that reflects a first total for first answer-set members that appear in the first results. Simultaneously, the second search is presented along with a second number that reflects a second total for second answer-set members that appear in the second results. Moreover, simultaneously the search is presented along with a third number that reflects a third total for third answer-set members that appear in the third results.

### BRIEF DESCRIPTION OF THE DRAWINGS

FIG. 1 is a diagram of a method for performing a database search and presenting the results, according to an example embodiment.

FIG. 2 is a diagram of another method for performing a database search and presenting the results, according to an example embodiment.

FIG. 3 is a diagram of search processing and search results presentation system, according to an example embodiment.

### DETAILED DESCRIPTION

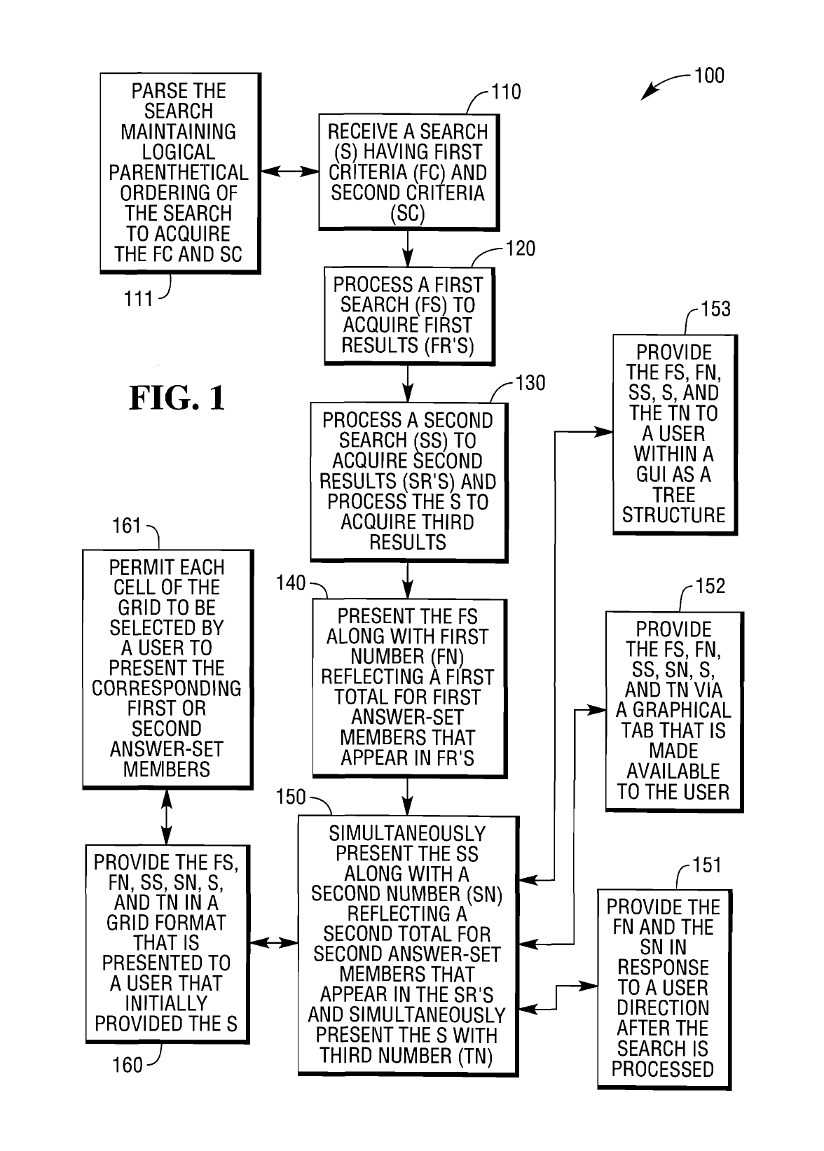

FIG. 1 is a diagram of a method 100 for performing a database search and presenting the results, according to an example embodiment. The method 100 (hereinafter “search service”) is implemented in a machine-accessible or computer-readable medium as instructions that when executed by a machine (e.g., computer, processing device, etc.) performs the processing depicted in FIG. 1. Moreover, the search service is optionally accessible over a network. The network may be wired, wireless, or a combination of wired and wireless.

A “database” as used herein is a relational database, or a collection of databases organized as a data warehouse. According to an embodiment, the database is a Teradata® product or service distributed by Teradata®, Inc.

The database includes a variety of enterprise information organized in tables. One type of information is referred to as an “entity.” An entity is something that can be uniquely identified (e.g., a customer account, a customer name, a household name, a logical grouping of certain types of customers, etc.).

A segment is a user-defined set of information obtained from one or more tables of the database. For example, a segment may include all customers living in North Carolina. Some segments may be predefined and selectable by a user. Other segments may be custom defined by a user or analyst to satisfy a particular problem. Conditions or Criteria define how to obtain the segment, such as “customers=all” and “state=NC” in the previous example.

It is within this context that the processing associated with the search service is now described in detail with reference to the FIG. 1.

At 110, the search service receives a search from a user. The search includes first criteria and second criteria. The criteria are in and of themselves independent portions of the search. For example, the first search criteria may be “find all customers that purchased items over $200 in the last month;” and the second search criteria may be “find all customers purchasing from stores in North Carolina last month.” Each search criteria may be viewed as an independent sub component of the overall search that itself could be executed as a search independent of the other search criteria.

It is also noted that although the discussion of FIG. 1 is made within the context of a first and second search criteria, the embodiments are not so restricted. In other words, there can be a variety of search criteria within a single search submitted by the user. The only upward restriction is that placed on the searching (e.g., SQL) interface that may restrict the search to a certain number of tables, terms, string length, etc. But, this is not a restriction of the search service; rather it is a restriction of the underlying searching interface or mechanism that is being used to conduct the searches.

According to an embodiment, at 111, the search service parses the search and maintains the logical parenthetical ordering originally present in the search. This is done to initially identify and extract out the first and second criteria. For example, suppose a search is as follows (A or B) and (C or D), where A, B, C, and D are search terms. The user submits the search as “(A or B) AND (C or D).” The search service parses the search to acquire as the first search criteria the string “(A or B)” and to acquire as the second search criteria “(C or D).” Thus, it can be seen how the original logical parenthetical ordering for the user-submitted search is maintained and actually used to acquire the first and second search criteria.

At 120, the search service processes a first search representing the first criteria to acquire first results. So, in the above example, the search service makes a first search that looks as follows “(A or B).” Execution of the first search against the target database results in the search service acquiring first results.

At 130, the search service processes a second search to acquire second results. Again the second search criteria are used in the second search, which in the example becomes “(C or D).” Execution of the second search against the target database results in the search service acquiring second results. The search service also processes the search, at 130, to acquire third results. So, at this point the search service has three different sets of results for the search that the user submitted: the first results (representing results for processing a first search as the first criteria parsed from the original search), the second results (representing results for processing a second search as the second criteria), and the third results (representing results for processing the search as a whole).

At 140, the search service acquires counts for items that appear in the first results. These counts may be referred to herein as waterfall counts. The search service then presents the first search that was constructed and processed along with its first total representing first answer-set members that appear in the first results. In other words, the first search that was executed is presented to the user along with its waterfall count as determined by items present in the first results (acquired by processing the first search). So, in the present example, “(A or B)” when processed returns 20 answer-set items then the user is presented with “A or B=20.”

Simultaneously, at 150, the search service presents the second search along with a second number reflecting a second total for second answer set members that appear in the second results. So, in the present example, “(C or D)” when processed returns 10 answer set items then the user is presented with “C or D=10” at the same time the user sees on a single display screen “A or B=20.” Additionally, simultaneous to all that the user is also presented with the search itself along with a third number representing the answer-set items that appear in the overall search. In our continuing example, this is “(A or B) AND (C or D)=5.” Again, the user sees all at the same time and on the same screen: “(A or B)=20,” “(C or D)=10,” and “(A or B) AND (C or D)=5.”

Thus, the user can visualize how his/her original search can be expected to return results using different combinations of the search. This can help the user identify components of the search that may be too inclusive or too restrictive and help the user refine the search to get manageable or a desired number of results.

According to an embodiment, at 151, the search service provides the first number (waterfall count for the first search) and the second number (waterfall count for the second search) in response to user direction after the search is processed as a whole for the user. So, the user may request the decomposition after the search is actually processed and an interface to the search service can acquire the user instruction or direction and provide the first and second numbers back to the user.

In another case, at 152, the search service provides the first search, the first number, the second search, the second number, the search, and the third number via a graphical tab available to the user. So, a tab is presented with the results of a search that the user can select and activate. Once the tab is activated the breakdown of the waterfall counts for the search and the first and second searches are presented to the user for inspection.

In still another embodiment, at 153, the search service provides the first search, the first number, the second search, the second number, the search, and the third number to the user within a Graphical User Interface (GUI) as a tree structure. So, the user can visualize tree decomposition for the search that the user provided and the user can interact with the nodes of the tree to get more detail. Each node of the tree representing the first search, the second search, or the search as a whole.

In yet another situation, at 160, the first search, the first number, the second search, the second number, the search, and the third number are provided to the user in a grid format. This is similar to a table format where the user can readily inspect each component of the search and its answer set item count (waterfall counts).

In some cases, at 161, the search service can also permit each cell of the grid to be a selectable item, which when selected by the user presents the corresponding first or second answer set items or members.

One now appreciates how a search can be decomposed and the logical parenthetical ordering maintained to acquire multiple independent sub searches that comprise the original search. Each sub search is processed and the waterfall counts for each sub search along with the search texts themselves are simultaneously presented to the user in a variety of manners, such as tab activated, tree structure, grid layout, etc. This permits the user to readily inspect the search and refine or enhance it as desired.

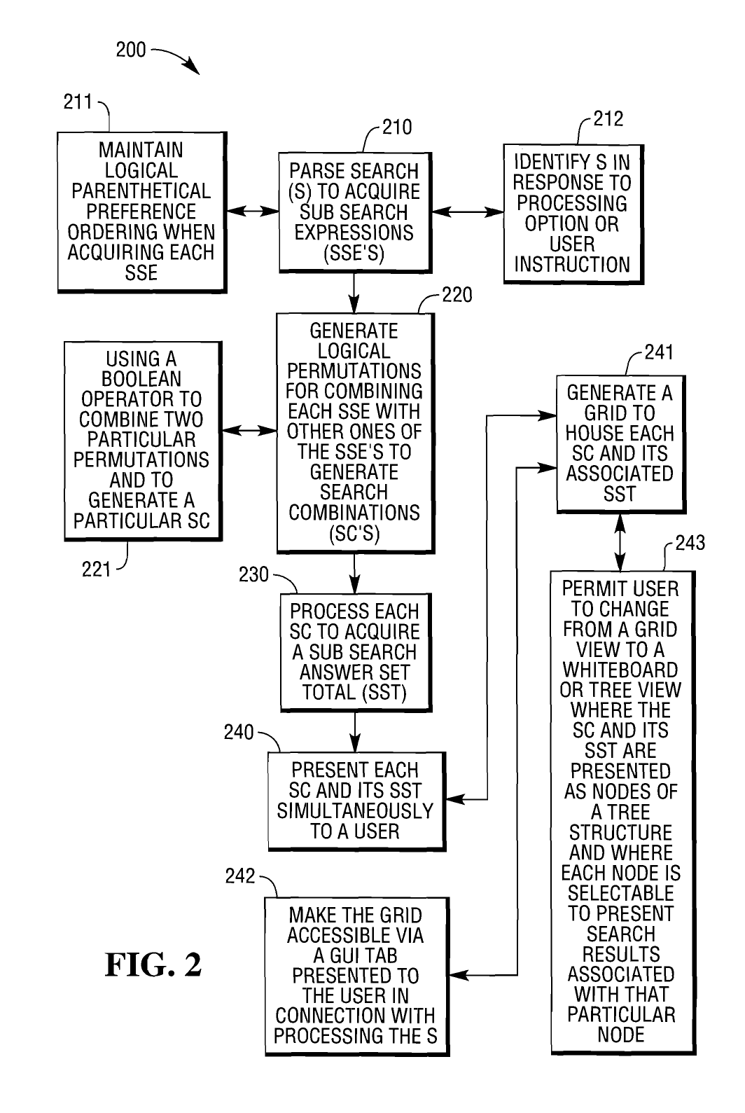

FIG. 2 is a diagram of another method 200 for performing a database search and presenting the results, according to an example embodiment. The method 200 (hereinafter “waterfall count service”) is implemented in a machine-accessible and readable medium as instructions that when executed by a machine performs the processing reflected in FIG. 2. The waterfall count service may also be accessible over a network. The network may be wired, wireless, or a combination of wired and wireless. The waterfall count service presents an alternative view and in some cases enhanced view of the search service presented above and represented by the method 100 of the FIG. 1.

At 210, the waterfall count service parses a search to acquire sub search expressions. Each sub search expression is an independent search that can be processed against a target database independent of remaining sub search expressions that comprise the overall search.

In an embodiment, at 211, the sub search expressions are identified by maintaining logical parenthetical preference ordering present in the original search. So, the search can be processed and each paired parenthetical that comprises the search can be identified as a sub search expression. For example, the search (A or B) and (C or D) includes two sub search expressions: 1) “A or B;” and 2) “C or D.”

According to an embodiment, at 212, the waterfall count service can identify the search in response to a processing option or user instruction. So, a user may have a search option that states it wants the waterfall count service to process the searches of the user automatically to provide waterfall counts for the components of the search. Alternatively, even after the search processes a user may interact with the waterfall count service and specifically provide an instruction requesting the waterfall counts.

At 220, the waterfall count service generates logical permutations for combining each sub search expression with other ones of the sub search expressions to generate search combinations. Examples of this were presented above, where “A or B” and “C or D” may be viewed as a search combination.

In an embodiment, at 221, Boolean operators may be used to combine to particular permutations with one another, such as via AND, OR, AND NOT, etc. The Boolean operator when applied to permutations results in a particular search combination.

At 230, the waterfall count service processes each search combination to acquire a sub search answer set total. This may be viewed as a waterfall count.

At 240, the waterfall count service presents each search combination and its sub search answer set total (waterfall count) to the user. The user can see each search combination and its corresponding waterfall count at one time on the same screen and simultaneously to see how the search is actually progressing and its impact to the overall search results for the search as a whole.

In an embodiment, at 241, the waterfall count service generates a grid to house each search combination and its associated sub search answer set total (waterfall count). The gird provides a mechanism for the user to easily comprehend and digest the various components of the search and impacts to the overall search as a whole.

In some cases, at 242, the waterfall count service makes the grid accessible via a GUI tab presented to the user in connection with processing the search. So, the user may process the search and have a tab that can be selected for visualizing the waterfall counts of sub components of the search or the search as a whole.

In another situation, at 243, the waterfall count service permits the user to change from a grid view to a whiteboard or tree view. In a whiteboard or tree view the search combinations and their waterfall counts are presented as nodes of a tree structure. Each node is selectable by the user to present search results associated with that particular node. Each node also clearly identifies the search combination to which it relates and that search combination's waterfall count.

Thus, the user can toggle between different views of the search combinations and their waterfall counts depending upon the desired preferences of a particular user. In other words, the manner in which the search decomposition and the waterfall counts are displayed to the user can be customized and dynamically changed on-the-fly by the user.

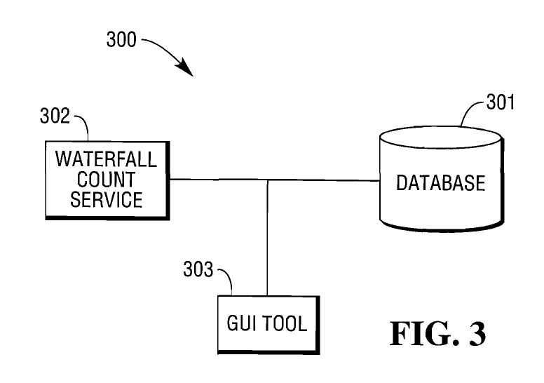

FIG. 3 is a diagram of search processing and search results presentation system 300, according to an example embodiment. The search processing and search results presentation system 300 is implemented in a machine-accessible and readable medium and is operational over a network. The network may be wired, wireless, or a combination of wired and wireless. In an embodiment, portions of the search processing and search results presentation system 300 implements, among other things the search service and the waterfall count service represented by the methods 100 and 200 of the FIGS. 1 and 2, respectively.

The search processing and search results presentation system 300 includes a database 301 and a waterfall count service 302. In some cases, the search processing and search results presentation system 300 may also include a Graphical User Interface (GUI) tool 303. Each of these and their interactions with one another will now be discussed in turn

The database 301 may be a relational database or a collection of relational databases organized and cooperating as a data warehouse. The database 301 resides within and is accessible from a machine-readable medium. According to an embodiment, the database 301 is a Teradata® product distributed by NCR, Corporation of Dayton, Ohio.

The database 301 houses a variety of tables for enterprise data. Each table may have its own schema definition that defines the fields and other aspects of the table and the data that the table may house. An Application Programming Interface (API) may be used to access and perform operations on the database 301. One aspect of the API includes a database query language, such as SQL. The database 301 interacts with the waterfall count service 302 and, optionally, a GUI tool 303.

The waterfall count service 302 is also implemented in a machine-accessible medium and is processed on a machine. The waterfall count service 302 is to access the database 301 via searches to acquire search results. Example processing associated with the waterfall count service 302 was presented above in detail with reference to the methods 100 and 200 of the FIGS. 1 and 2, respectively.

The waterfall count service 302 is to decompose a search into a plurality of search combinations and is to then process each search combination against the database 301 to acquire a waterfall count for each processed search combination. Next, each search combination and its waterfall count are presented to a user that made the original search request.

The search combinations are independent searches that can be processed against the database 301. Moreover, the search combinations are acquired by the waterfall count service 302 by parsing the original submitted search and acquiring nested parenthetical expressions within the search. The parenthetical ordering is maintained when the search combinations are acquired.

In some embodiments, the search processing and search results presentation system 300 also includes a GUI tool 303. The GUI tool 303 resides within a machine-accessible medium and processes on a machine. The GUI tool 303 is to present a first tab within a display to the user for that user to access a particular search answer set associated with results for processing the search. Moreover, the GUI tool 303 is to present a second tab to the user for the user to access a grid view or tree view that depicts each search combination and its waterfall count relative to remaining ones of the search combinations and their waterfall counts.

The GUI tool 303 permits each search combination and its waterfall count to be selected by the user for purposes of acquiring sub results associated with processing that particular search combination against the database 301.

According to an embodiment, the GUI tool 303 permits the user to dynamically switch between a grid view and a tree view of the search combinations and their waterfall counts.

In another embodiment, the GUI tool 303 includes an export feature that permits the user to export the search combinations and their waterfall counts to a file or to another application or service.

In yet another embodiment, the GUI tool 303 permits the user to selectively highlight multiple search combinations simultaneously and acquire new automatically calculated waterfall counts for the highlighted search combinations.

The techniques presented herein include a variety of benefits that can be utilized in the industry. For example, marketing users can now have the capability to determine waterfall counts for their customer segment criteria that takes into account operator precedence and parenthesis in the search and that is not simply based on the order of search entry made by a user. Moreover, details as to how the search counts flow in a waterfall for the segment based on each individual criteria and its interaction with other criteria is now possible.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
receiving a search having first criteria and second criteria;
processing a first search for the first criteria to acquire first results;
processing a second search for the second criteria to acquire second results;
processing the search to acquire third results;
presenting the first search along with a first number reflecting a first total for first answer-set members that appear in the first results;
simultaneously presenting the second search along with a second number reflecting a second total for second answer-set members that appear in the second results; and
simultaneously presenting the search along with a third number reflecting a third total for third answer-set members that appear in the third results.

2. The method of claim 1 further comprising, providing the first search, the first number, the second search, the second number, the search, and third number in a grid format that is presented to a user that initially provided the search.

3. The method of claim 2 further comprising, permitting each cell of the grid to be selected by a user to present the corresponding first, second, or third answer-set members.

4. The method of claim 1, wherein presenting and simultaneously presenting further includes providing the first number and the second number in response to a user direction.

5. The method of claim 1, wherein presenting and simultaneously presenting further includes providing the first search, the first number, the second search, the second number, the search, and the third number via a graphical tab that is made available to a user.

6. The method of claim 1, wherein presenting and simultaneously presenting further includes providing the first search, the first number, the second search, the second number, the search, and the third number to a user within a graphical user interface as a tree structure.

7. The method of claim 1, wherein receiving further includes parsing the search maintaining logical parenthetical ordering of the search to acquire the first criteria and the second criteria.

8. A machine-implemented method, comprising:
parsing a user-provided search to acquire a plurality of independent sub search expressions;
generating logical permutations for combining each of the sub search expressions with other ones of the sub search expressions to generate search combinations;
processing each search combination to acquire a sub search answer set total number; and
presenting each search combination and its associated sub search answer set total simultaneously to a user.

9. The method of claim 8, wherein parsing further includes maintaining logical parenthetical preference ordering when acquiring each sub-search expression.

10. The method of claim 8, wherein generating further includes using any BOOLEAN operator to combine two particular permutations and to generate a particular search combination.

11. The method of claim 8, wherein parsing further includes identifying the search in response to a user-configured processing option or a user-provided instruction made in connection with the user-provided search.

12. The method of claim 8, wherein presenting further includes generating a grid to house each search combination and its associated sub search answer set total.

13. The method of claim 12, wherein presenting further includes making the grid accessible via a graphical user interface tab presented to the user in connection with processing the user-provided search.

14. The method of claim 12, wherein presenting further includes permitting the user to change from a grid view associated with the grid to a whiteboard or a tree view where each search combination and its associated sub search answer set total are presented as nodes of a tree structure in graphical user interface, and wherein each node is selectable to present search results associated with that particular node.

15. A system comprising:
a database accessible from a machine-accessible medium; and
a waterfall count service residing in the machine-accessible medium and to process on a machine, the waterfall count service is to decompose a search into a plurality of search combinations and is to process each search combination against the database to acquire a waterfall count for each search combination, and wherein each search combination and its waterfall count is presented to a user that made the original search.

16. The system of claim 15 further comprising, a Graphical User Interface (GUI) tool residing within the machine-accessible medium to process on the machine, and wherein the GUI tool is to present a first tab to the user for the user to access a search answer set associated with results for processing the search and is to present a second tab to the user for the user to access a grid view or tree view that depicts each search combination and its waterfall count relative to remaining ones of the search combinations and their waterfall counts.

17. The system of claim 16, wherein each search combination and its waterfall count is selectable by the user to acquire sub results associated with processing that particular search combination against the database.

18. The system of claim 16, wherein the GUI tool is to dynamically permit the user to switch between the grid view and the tree view.

19. The system of claim 16, wherein the GUI tool is to provide an export feature that permits the user to export the search combinations and their waterfall counts to a file or to another application.

20. The system of claim 15, wherein the GUI tool is to permit the user to highlight multiple search combinations simultaneously and acquire new waterfall counts for the highlighted search combinations.
